(19) United States
(12) Patent Application Publication
(10) Pub. No.: US 2014/0209650 A1
(43) Pub. Date: Jul. 31, 2014

(54) BRACKET AND MOUNTING ASSEMBLY FOR SECURING A BAG TO A WINDSHIELD

(71) Applicant: Gregory Hughes, Milwaukee, WI (US)

(72) Inventor: Gregory Hughes, Milwaukee, WI (US)

(21) Appl. No.: 13/755,369

(22) Filed: Jan. 31, 2013

(51) Int. Cl. B60R 7/00

(52) U.S. Cl. CPC B60R 7/00
USPC 224/557; 224/555

(57) ABSTRACT

A bracket is used to mount an accessory bag to a curved vehicle windshield, providing a planar bag mounting surface to prevent distortion of the bag. Angularly arranged planar surfaces of the bracket allow for mounting to windshields of varying curvatures. A mounting assembly including the bracket enables the bag to be secured to the windshield in a variety of configurations and locations on the windshield.

### BACKGROUND

Compact vehicles such as motorcycle, scooters, all-terrain vehicles, snowmobiles, and similar vehicles typically lack adequate storage space for the personal effects of the vehicle driver or operator. This has been only partially addressed by the use of saddle bags and the like, since items stored in these types of storage compartments are not readily accessible by the driver of the vehicle while the vehicle is in motion. The amount of space available for use as storage within the easy reach of the driver is very limited indeed, and past solutions to this problem have not been found to be satisfactory.

Many of the compact vehicles described above are provided with a transparent windshield in front of the driver to protect the driver from wind, precipitation, and road debris. Substantial variations can be found in the windshield, from vehicle to vehicle. For example, the windshield may be detachable or it may be permanently mounted, and it may be provided with or without metal support bars. It is, on occasion, desirable for the windshield to be used as a support structure to mount a bag or similar receptacle, so that the personal effects of the driver can be stored in a location that is readily accessible to the driver while operating the vehicle.

Such use of the windshield can, however, be problematic. Most of such windshields are curved, while the bags desired to be mounted thereon are typically flat. Frequently the attachment of the bag to the curved windshield results in distortion of the bag. The distortion of the bag can cause cracking of the bag material, which can be both aesthetically displeasing and damaging to the overall structural integrity of the bag.

U.S. Pat. No. 6,808,096 to Salasny, Sr. describes an attempt to solve the foregoing problem by the use of a bracket that can be mounted to a curved windshield, and provides a planar mounting surface to attach the bag thereto. However, this bracket is very limited in its applicability, as it is only compatible with detachable windshields having a horizontal cross bar with a center mounting hole. Furthermore, that bracket is limited to use on a windshield having a radius of curvature that matches the radius of curvature of the bracket's curved surface. Additionally, even on windshields that comply with the above requirements, a bag can only be mounted using this bracket at a height corresponding to the location of the horizontal cross bar, thus severely limiting the choices of the vehicle operator as to the positioning of the bag.

### SUMMARY

According to an embodiment of the invention, a bracket to mount a bag to a windshield of a vehicle includes a body with a planar surface to which the bag is mounted. A first mounting tab extends from a side of the body that is opposite to the planar mounting surface, and defines a second planar surface that is oriented as an acute angle to the first planar surface. A second mounting tab also extends from the side of the body opposite to the first planar mounting surface, and defines a third planar surface, also oriented at an acute angle to the first planar surface. The second mounting tab is spaced apart from the first mounting tab.

In some embodiments, the first and second mounting tabs are arranged substantially symmetrically about a center plane of the body. In some such embodiments the second and third planar surfaces are both tangent to a common arc centered on the center plane.

In some embodiments, apertures extend through the second and third planar mounting surfaces so that a fastener can be received through the apertures. In some such embodiments, inserts are received into the first and second mounting tabs, and threaded fasteners are received into the inserts. Rotation of the inserts within the mounting tabs, and rotation of the threaded fasteners within the inserts, is prevented.

According to another embodiment of the invention, a mounting assembly for securing a bag to a vehicle windshield includes a bracket located inboard of the windshield. The bracket includes a body, and mounting tabs extending from the body. Threaded fasteners extend through holes in the windshield and apertures in the mounting tabs to secure the bracket to the windshield, while additional fasteners secure the bag to the body of the bracket.

In some embodiments, deformable washers are included in the mounting assembly to conform to curved surfaces of the windshield. In some such embodiments at least some of the deformable washers are disposed against planar surfaces of the bracket. The planar surfaces of the bracket are angled with respect to the bag mounting surface.

In some embodiments the mounting assembly is secured to the windshield using a horizontal support bar of the windshield.

### BRIEF DESCRIPTION OF THE DRAWINGS

FIG. 1 is a perspective view of a bracket according to an embodiment of the present invention.

FIG. 2 is another perspective view of the bracket of FIG. 1.

FIG. 3 is a perspective view of an accessory bag suitable for mounting using the bracket of FIG. 1.

FIG. 4 is a perspective view of the accessory bag of FIG. 3 mounted to the bracket of FIG. 1.

FIG. 5 is a perspective view of the accessory bag of FIG. 3 mounted to a vehicle windshield using a mounting assembly according to another embodiment of the present invention.

FIG. 6 is a perspective view of the embodiment of FIG. 5, with portions of the windshield removed for clarity.

FIG. 7 is a top view of the embodiment of FIG. 5.

FIG. 8 is a partially exploded perspective view of the mounting assembly of FIG. 5.

FIG. 9 is a perspective view of the accessory bag of FIG. 3 mounted to a vehicle windshield using a mounting assembly according to yet another embodiment of the present invention.

FIG. 10 is a perspective view of the embodiment of FIG. 9, with portions of the windshield removed for clarity.

FIG. 11 is a perspective view of the accessory bag of FIG. 3 mounted to a vehicle windshield using a mounting assembly according to yet another embodiment of the present invention.

FIG. 12 is a perspective view of the embodiment of FIG. 9, with portions of the windshield removed for clarity.

FIG. 13 is a partially exploded perspective view of the mounting assembly of FIG. 11.

FIG. 14 is a perspective view of the accessory bag of FIG. 3 mounted to a vehicle windshield using a mounting assembly according to yet another embodiment of the present invention.

FIG. 15 is a perspective view of the accessory bag of FIG. 3 mounted to the mounting assembly of FIG. 14.

FIG. 16 is a perspective view of the accessory bag of FIG. 3 mounted to a mounting assembly according to another embodiment of the present invention.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

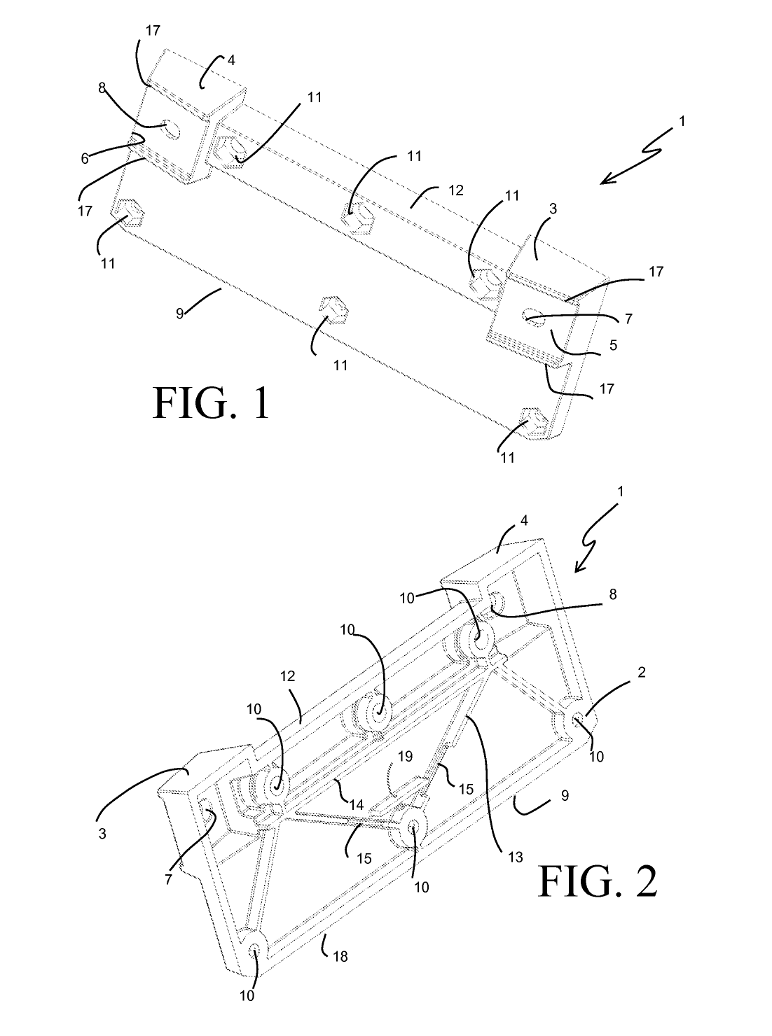

A bracket 1 suitable for use in securing a bag to a vehicle windshield in accordance with an embodiment of the invention is shown and described in FIGS. 1 and 2. The bracket 1 includes a body portion 9, and first and second mounting tabs 3 and 4 attached at opposing ends to the body portion 9. In the exemplary embodiment the bracket 1 is an injection molded plastic part, such that the body 9 and the first and second mounting tabs 3 and 4 are integrally molded as a single component. In certain other embodiments, however, one or both of the mounting tabs 3 and 4 can be separate components that join to the body 9 in order to form the bracket 1. Alternatively, the bracket 1 can be formed as an integral structure including the body 9 and the mounting tabs 3 and 4 through a process, such as die casting or machining, for example.

As best seen in FIG. 2, the bracket 1 further includes a planar surface 2, covering what will be referred to as the back side of the bracket 1. A plurality of mounting holes 10 are provided in the planar surface 2, and provide locations for securing a bag to the planar surface 2 as will be described later. A total of six such mounting holes 10 are shown in the exemplary embodiment, but more or fewer such holes 10 can be provided. The mounting holes 10 can be circular, as shown in the exemplary embodiment, or they can alternatively be of a non-circular shape.

The mounting tab 3 defines a planar surface 5 facing in a direction that is generally opposite of the planar surface 2. As will be described in greater detail later, the planar surface 5 is oriented at an acute angle to the planar surface 2. Similarly, the mounting tab 4 define a planar surface 6 facing in a direction that is generally opposite of the planar surface 2, and is oriented at an acute angle thereto. Apertures 7 and 8 extend through the planar surfaces 5 and 6, respectively. Preferably the mounting tabs 3 and 4 each have a width that is substantially smaller than the width of the bracket 1. In some preferable embodiments the width of each of the mounting tabs 3 and 4 is approximately one inch.

The bracket 1 is preferably hollowed out in order to minimize weight and improve manufacturability. Optionally, a network of ribs 13 is provided in order to strengthen and stiffen the bracket 1.

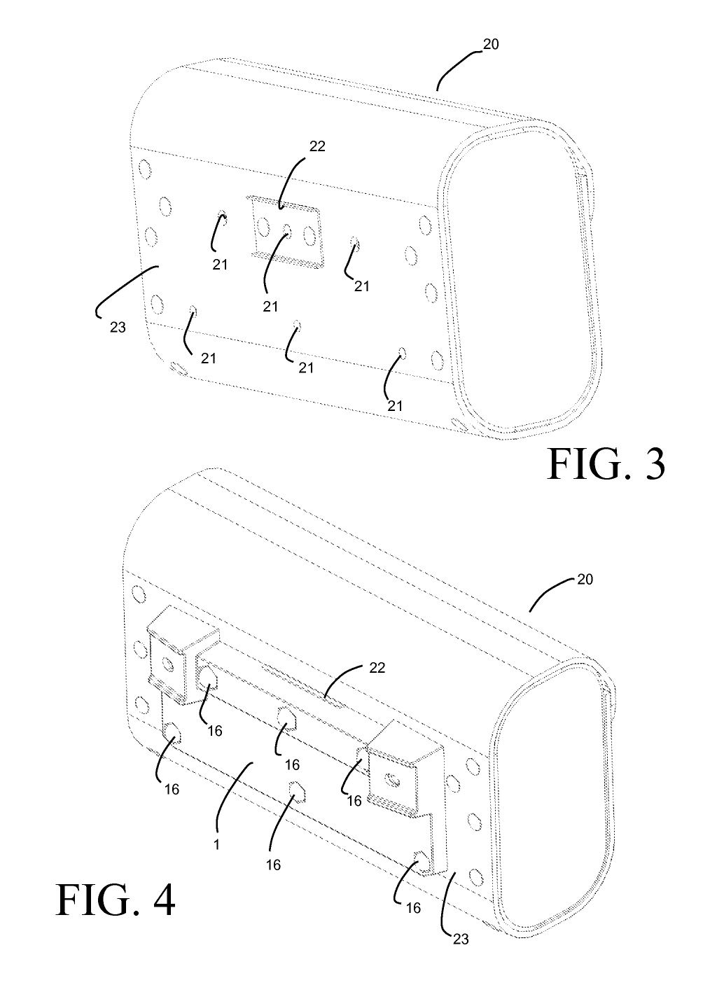

Turning now to FIG. 3, a bag 20 can be prepared for mounting to the bracket 1. The bag 20 can vary in shape, size, and material of construction, but is typically of a leather construction and of a size and shape that is well-suited for carrying small personal effects such as money, sunglasses, keys, and the like. A sheet metal mounting clip 22 is optionally provided on a mounting surface 23 of the bag 20, with the mounting surface 23 located at a back side of the bag opposite the bag opening. In order to prepare the bag 20 for mounting to the bracket 1, a plurality of holes 21, corresponding to at least some of the mounting holes 10 of the bracket 1, are provided through the mounting surface 23. One or more of the holes 21 may extend through the mounting clip 22, if it is present. In any event, it should be understood that the mounting clip 22 is optional, and that the present invention can be used to mount bags that lack such a clip.

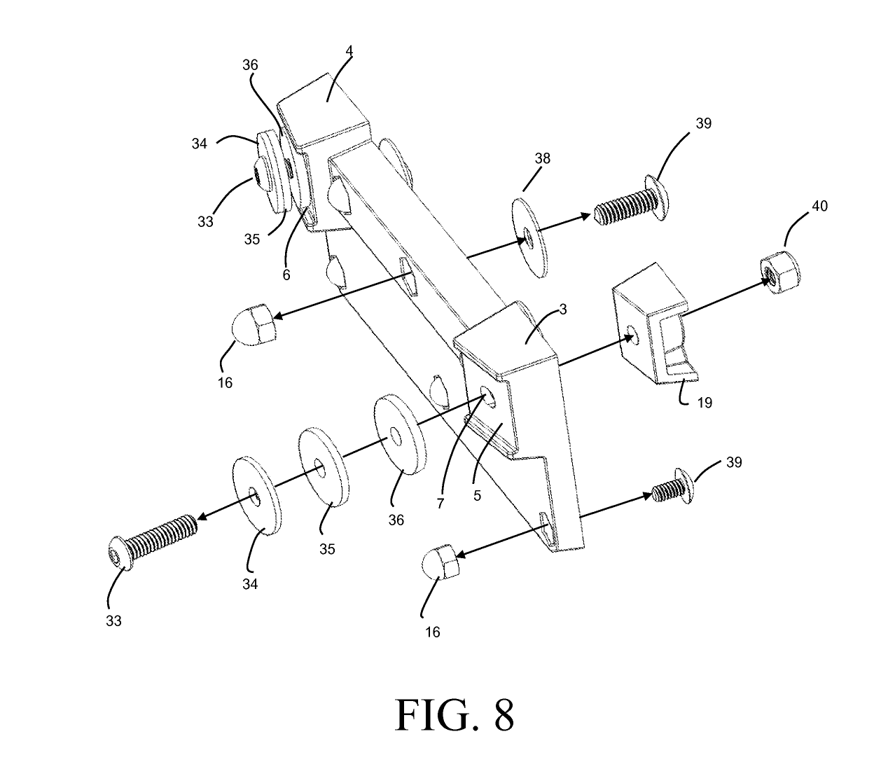

The bag 20 can be secured to the bracket 1 by mating the mounting surface 23 of the bag 20 to the planar surface 2 of the bracket 1, and by using threaded fasteners 39 (FIG. 8) extending through aligned pairs of the holes 21 and the holes 10. Washers 38 (FIG. 8) can optionally be used in the interior of the bag 20 to prevent tear-out or other damage to the holes 21, or to accommodate for the length of the fasteners. Each of the threaded fasteners 39 extends through one of the optional washers 38, through one of the holes 21 in the bag 20, through one of the holes 10 of the bracket 1, and is received by a matching threaded fastener 16. Hexagonal-shaped recesses 11 are provided in the bracket 1 at the ends of the holes 10, and are sized to receive the threaded fasteners 16 and prevent rotation thereof to provide a simple assembly method for securing the bag 20 to the bracket 1.

The top bent flange of the mounting clip 22 can engage against a top surface 12 of the bracket 1 in order to locate the bracket 1 on the bag 20, as well as to provide additional resistance to rotation between the bag 20 and the bracket 1. An additional support wall 14 is provided on the back side of the bracket 1 (see FIG. 2) to engage the bottom bent flange of the mounting clip 22.

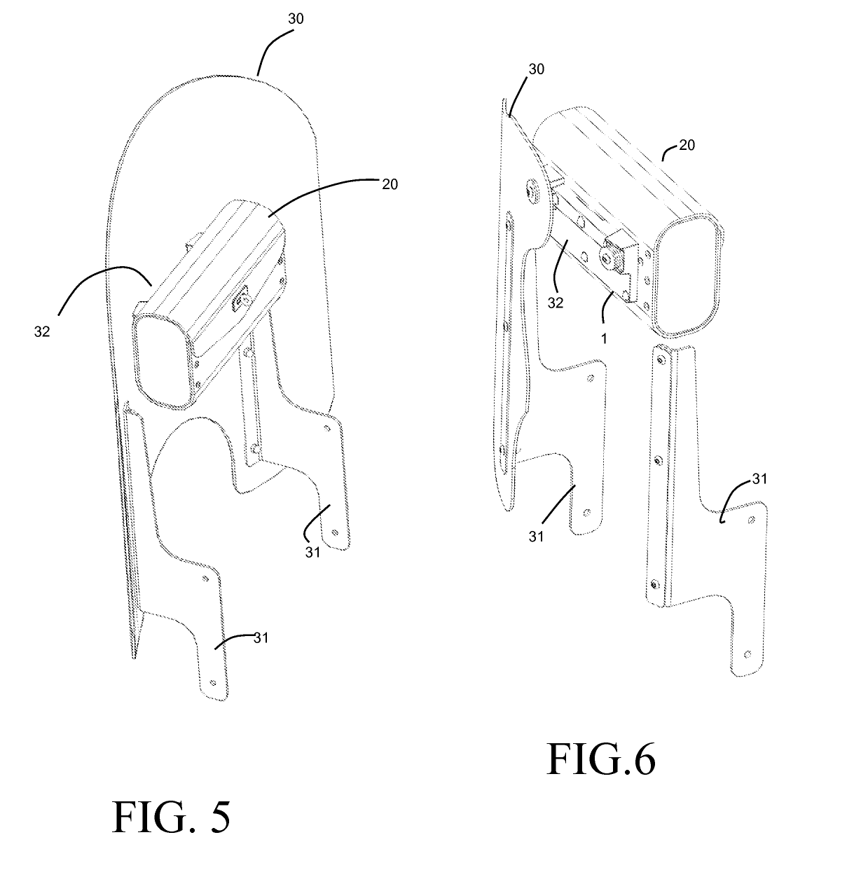

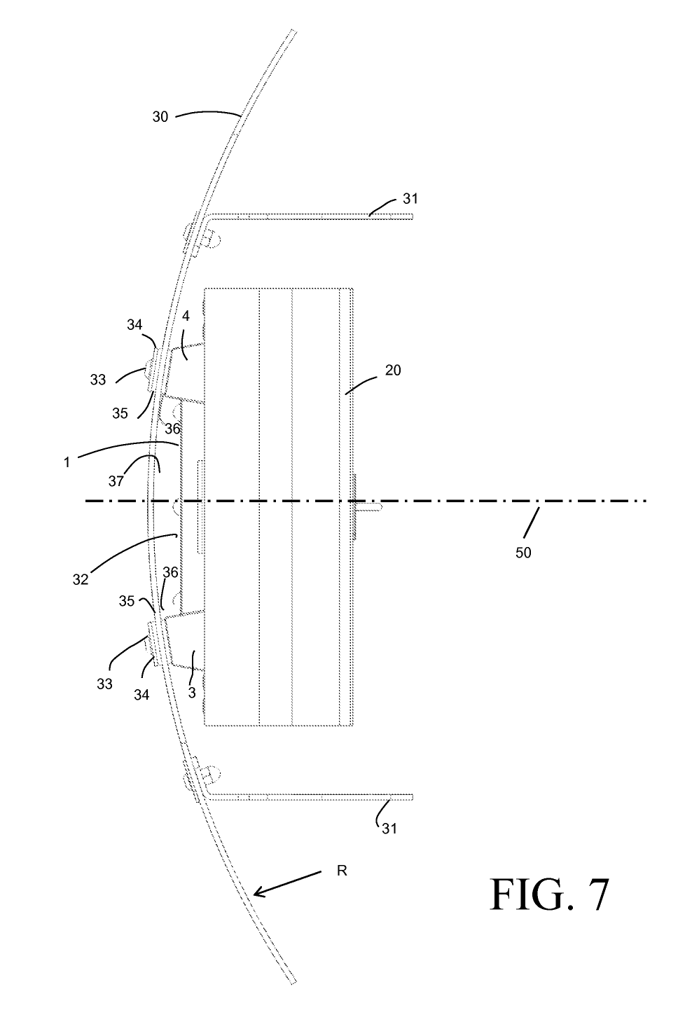

The bracket 1, threaded fasteners 39 and 16, and washers 38 are preferably part of a mounting assembly 32 which is provided as a kit to secure a bag such as the bag 20) to a vehicle windshield. Other components of the mounting assembly 32, and the manner by which it can be used to secure a bag to a windshield, will now be described, with specific reference to FIGS. 5-8.

A windshield 30 is shown, and is mounted by way of windshield brackets 31 to a vehicle (not shown) such as a motorcycle, scooter, ATV, snowmobile, or the like. The windshield 30 is curved in the yaw direction of the vehicle, with a radius of curvature in the exemplary embodiment of approximately twenty inches.

The windshield 30 is provided with a pair of holes located so as to align with the apertures 7 and 8 of the bracket 1 when the bag 20 is in the desired mounting location. Threaded fasteners 33 extend through the holes of the windshield 30 and through the apertures 7 and 8, and are secured into corresponding threaded fasteners 40. As shown in exploded view in FIG. 8, a fastener 40 is received into an insert 19, which is in turn received into the mounting tab 3 of the bracket 1. Although not shown exploded in FIG. 8, it should be understood that a similar insert 19 and threaded fastener 40 are located within the mounting tab 4 of the bracket 1. The insert 19 is provided with a hexagonal recess to receive the hexagonal fastener 40, so that rotation of the fastener 40 relative to the insert 19 is prevented during securing of the bracket 1 to the windshield 30 using the threaded fastener 33. Furthermore, the insert 19 is prevented from rotating within the mounting tabs 3, 4. The inserts 19, fasteners 33, and fasteners 40 are additional components of the mounting assembly 32.

In order to provide a secure and snug connection between the windshield 30 and the bracket 1, the mounting assembly 32 further includes rigid flat washers 34, and compliant washers 35 and 36. The rigid flat washers 34 are conventional metal washers, whereas the compliant washers 35 and 36 are of a rubber, elastomeric, or similar material. The compliant washers 35 and 36 are arranged on opposing sides of the windshield 30, with the rigid flat washers 34 disposed between the heads of the fasteners 33 and the compliant washers 35, and with the compliant washers 36 pressed against the planar surfaces 5 and 6 of the bracket 1.

As best seen in FIG. 7, the mounting tabs 3 and 4 are arranged symmetrically about a center plane 50 of the mounting bracket 1, the center plane 50 being oriented perpendicular to the planar face 2 of the bracket. Further, the planar surfaces 5 and 6 are angled relative to the center plane 50 such that they are approximately tangent to a common circular arc centered on the center plane 50. In other words, a single arc can be constructed whose center is located on the center plane 50, and which is tangent to both the planar surface 5 and the planar surface 6. Preferably, the radius of that arc is approximately equal to the radius R of the windshield. In some preferable embodiments the radius of that arc is between fifteen and twenty-five inches in order to accommodate a broad range of vehicular windshields. In a highly preferable embodiment, the radius of that arc is approximately twenty inches.

Due to the relatively narrow width of the mounting tabs 3 and 4, a moderate discrepancy between the radius R of the windshield and the radius of the tangent arc will result in only a slight mismatch between the planar surfaces 5, 6 and the inner surface of the windshield. Such a slight mismatch can be easily accommodated by the compliancy of the washer 36. In a similar fashion, the compliancy of the washer 35 can accommodate the mismatch between the curved surface of the windshield 30 and the flat surface of the rigid washer 34. As an additional advantage, a clearance 37 is created between the windshield 30 and the body 9 of the bracket 1 in the region between the mounting tabs 3 and 4. This clearance 37 facilitates regular cleaning of the windshield in that area, providing improved aesthetics. Additionally, the clearance 37 prevents the bag 20 from rubbing against the windshield 30 because of vibrations, thus preventing wear on the inside surface of the windshield 30.

The mounting assembly 32 and bracket 1 enable the bag 20 to be mounted on a wide variety of windshield sizes, and further enable the bag 20 to be mounted at various heights and locations on the windshield in order to accommodate the desires of the driver.

Although the exemplary embodiments in the accompanying figures make use of threaded fasteners, it should be understood that various types of non-threaded fasteners can be used instead. For example, rivets, snaps, or other thread-less fasteners can be substituted for one or more of the threaded fasteners previously described without departing from the invention.

In some embodiments, certain components of the mounting assembly 32 need not be present. For example, the washers 38 and/or 34 can be eliminated, or can be integrated with the fasteners 33 and/or 39. In other embodiments the inserts 19 and fasteners 40 can be eliminated, and a self-tapping or thread-cutting screw can be used as the fastener 33. In still other embodiments the fasteners 40 can be provided as captured components within the bracket 1, such as by insert molding. In other embodiments of the invention, additional components can be provided, as will be described hereafter.

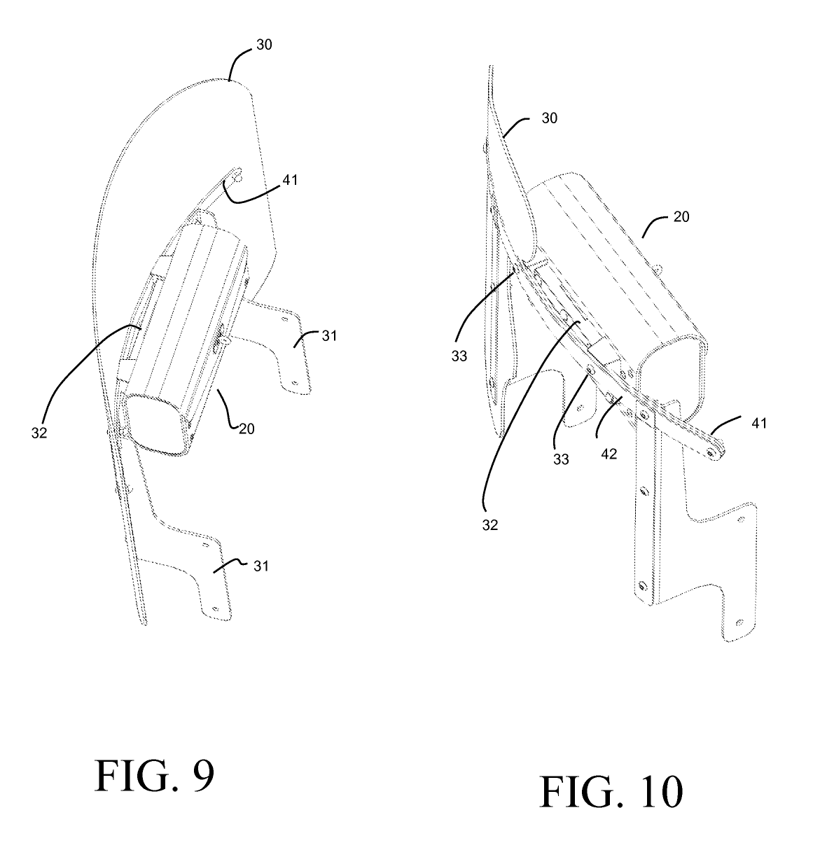

An alternative embodiment of the invention is illustrated in FIGS. 9 and 10, where the windshield 30 includes a metal internal horizontal support bar 41 and metal external horizontal support bar 42. In this embodiment, the compliant washers 35 and 36 are not needed. Instead, holes can be provided through the horizontal supports bars 41 and 42, and the fasteners 33 can extend through the holes to secure the planar surfaces 5, 6 to the internal horizontal support bar 41. A lip 17 is provided at both the top and the bottom edge of each of the planar surfaces 5, 6 so that the horizontal support bar 41 engages between the lips 17 and rotation of the bracket 1 relative to the support bar 41 is further prevented. Such lips 17 are preferably small enough in size so that the compliant washers 36 disposed between the planar surfaces 5, 6 and the internal surface of the windshield 30 prevent contact between the lips 17 and the windshield 30 in the case where the bracket 1 is mounted to the windshield 30 as previously described, without the use of a horizontal support bar.

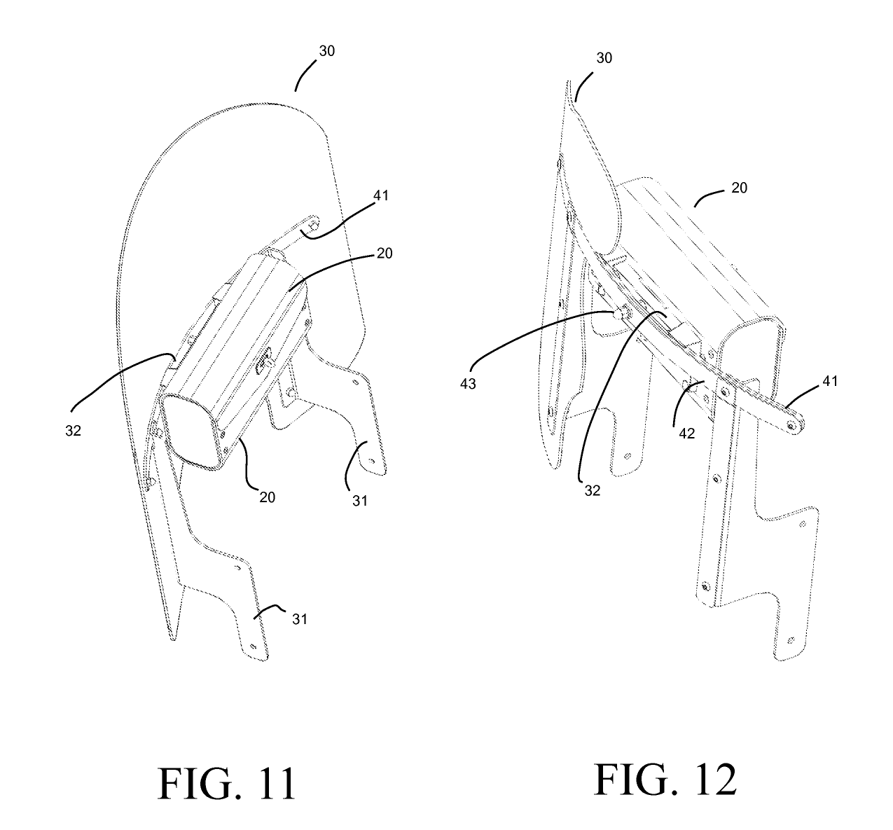

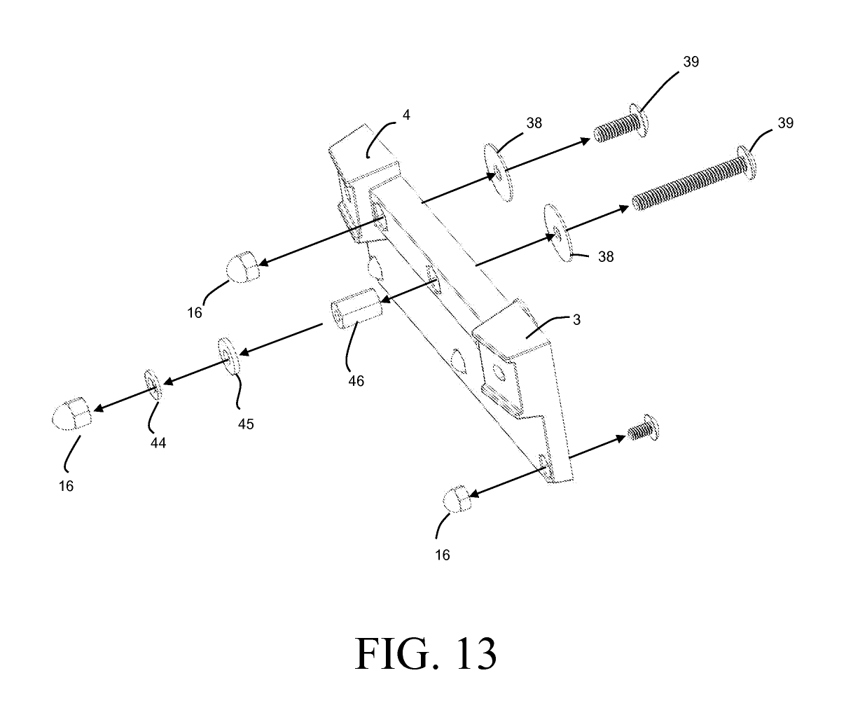

Yet another alternative embodiment of the invention is illustrated in FIGS. 11-13. In this embodiment the bracket 1 is again mounted using horizontal support bars 41 and 42. A center hole is provided through the bars 41 and 42, and the windshield therebetween, to facilitate the mounting of the bracket 1. The fasteners 33 (along with associated hardware 34, 35, 36, 19, and 40) are eliminated, and instead a lengthened fastener 39 extends sequentially through a washer 38, the bag 20, the bracket 1, a standoff 46, the internal horizontal support bar 41, the windshield 30, the external horizontal support bar 42, a flat washer 45, a lock washer 44, and a threaded fastener 43. Referring again to FIGS. 1 and 2, preferred one of the mounting holes 10 to receive the lengthened fastener 39 is provided with its axis at the intersection of a center plane of the bracket body portion 9 (centered between the mounting tabs 3 and 4), and a plane extending through approximately the centers of the mounting tabs 3 and 4, so that the lips 17 are spaced equidistantly from that plane. The required holes in the windshield 30 and in the horizontal support bars 41 and 42 are often already provided at the center of the horizontal support bars, thus eliminating the need for adding additional holes to the windshield. The lips 17 on the bracket 1 again prevent rotation of the bag 20.

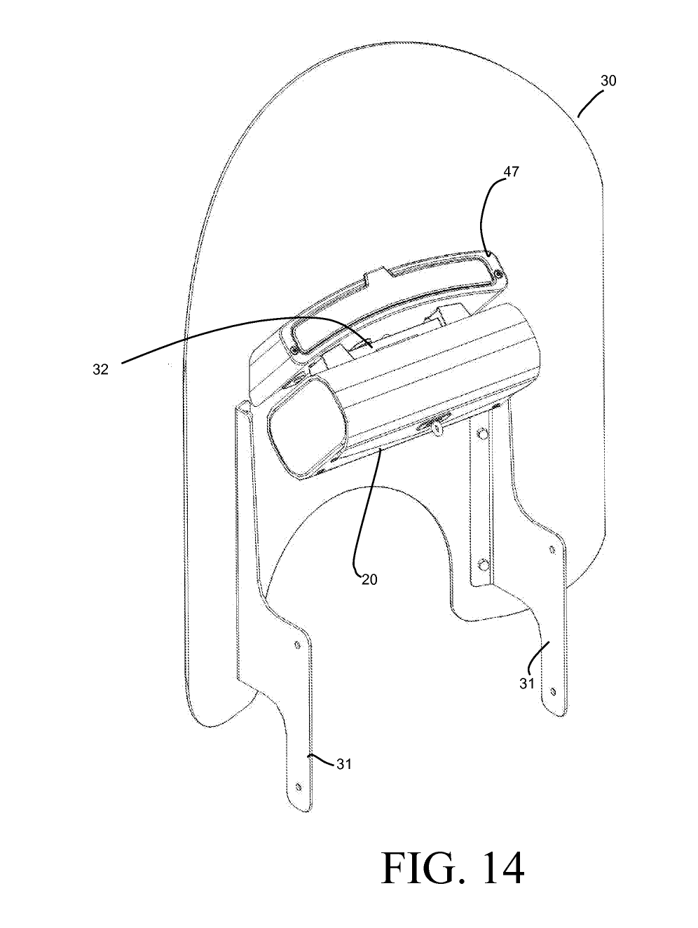

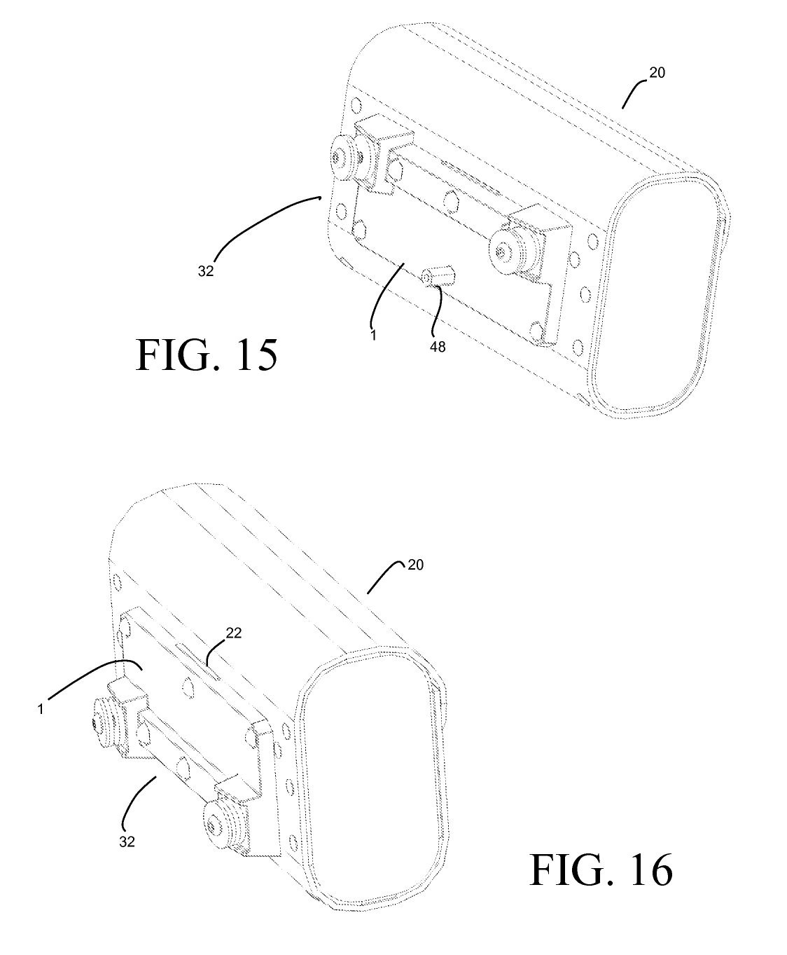

Still another alternative embodiment is shown in FIGS. 14-15, and includes an air vent 47 provided on the windshield 30. In this embodiment, the bag 20 is indirectly mounted to the windshield 30 by attaching to the air vent 47. The bracket 1 and associated hardware are used as before, with corresponding holes being provided in the air vent 47 in place of in the windshield 30. An additional stand-off 48 is optionally used in place of the bottom center one of the threaded fasteners 16 in order to counteract the moment that results from the force of gravity when the bag is mounted in such an orientation, but is not required.

As seen in the alternative embodiment of FIG. 16, the bracket 1 is additionally capable of being used in a 180 degree rotated orientation. When used in such an orientation, the apertures 7 and 8 by which the bracket 1 is secured to the windshield are located lower on the bag, thereby allowing the bag 20 to be mounted at a location that is vertically higher on the windshield. Again, the bracket 1 can be used to mount a bag 20 with a mounting clip 22, as well as without a mounting clip 22, in the rotated orientation illustrated in the embodiment of FIG. 16. In the case of a bag with a mounting clip 22, the top bent flange of the clip can engage against the surface 18 of the bracket 1 (see FIG. 2). An additional wall 19 is provided to similarly engage the bottom bent flange of the mounting clip 22. Clearances 15 provided in the rib walls 13 of the bracket 1 allow the bracket to accommodate mounting clips 22 of various widths in the rotated orientation of FIG. 16.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A bracket for mounting a bag to a windshield, comprising:
a body having a first planar surface for securing a bag thereto;
a first mounting tab extending from a side of the body opposite the first planar surface and defining a second planar surface oriented at an acute angle to the first planar surface; and
a second mounting tab extending from said side of the body opposite the first planar surface and defining a third planar surface oriented at an acute angle to the first planar surface, the second mounting tab being spaced apart from the first mounting tab.

2. The bracket of claim 1, wherein the first and second mounting tabs are arranged substantially symmetrically about a center plane of the body.

3. The bracket of claim 2, wherein the second and third planar surfaces are both tangent to a common arc centered on said center plane of the body.

4. The bracket of claim 3, wherein said arc is between 15 and 25 inches in radius.

5. The bracket of claim 4, wherein said arc is between 19 and 21 inches in radius.

6. The bracket of claim 1, further comprising a first aperture extending through the second planar surface to receive a fastener therethrough, and a second aperture extending through the third planar surface to receive a fastener therethrough.

7. The bracket of claim 6, further comprising:
a first insert received into the first mounting tab;
a first threaded fastener received into the first insert;
a second insert received into the second mounting tab; and
a second threaded fastener received into the second insert, wherein the first threaded fastener is aligned with the first aperture, the second threaded fastener is aligned with the second aperture, and rotation of the first threaded faster within the first insert, rotation of the first insert within the first mounting tab, rotation of the second threaded fastener within the second insert, and rotation of the second insert within the second mounting tab is prevented.

8. The bracket of claim 1, wherein the body, the first mounting tab, and the second mounting tab are an integrally molded plastic part.

9. The bracket of claim 1, further comprising:
a first and a second lip arranged at opposing edges of the second planar surface; and
a third and a fourth lip arranged at opposing edges of the third planar surface.

10. The bracket of claim 9, further comprising a mounting hole having an axis extending along a center plane of the body, the first and second mounting tabs being arranged substantially symmetrically about the center plane of the body, the axis extending along a second plane orthogonal to the center plane of the body, said opposing edges of the second planar surface and said opposing edges of the third planar surface being approximately equidistant from the second plane.

11. The bracket of claim 1, further comprising a plurality of mounting holes arranged on the first planar surface to secure the bag thereto.

12. A mounting assembly for securing a bag to a vehicle windshield, comprising:
a bracket located inboard of the windshield, including a body and first and second mounting tabs extending from the body;
a first threaded fastener extending sequentially through a first hole provided in the windshield and an aperture in the first mounting tab to secure the bracket to the windshield;
a second threaded fastener extending sequentially through a second hole provided in the windshield and an aperture in the second mounting tab to secure the bracket to the windshield; and
a plurality of third fasteners extending through a rear surface of the bag and through corresponding holes in a planar surface of the bracket to secure the bag to a planar surface of the body.

13. The mounting assembly of claim 12, further comprising:
a first rigid washer arranged under a head of the first threaded fastener on an outboard side of the windshield;
a first deformable washer secured between the first rigid washer and the windshield in the vicinity of the first hole, and conforming to both a flat surface of the first rigid washer and a curved outer surface of the windshield;
a second deformable washer secured between the first mounting tab and the windshield in the vicinity of the first hole, and conforming to both a planar surface of the first mounting tab and a curved inner surface of the windshield;
a second rigid washer arranged under a head of the second threaded fastener on an outboard side of the windshield;
a third deformable washer secured between the second rigid washer and the windshield in the vicinity of the second hole, and conforming to both a flat surface of the second rigid washer and a curved outer surface of the windshield; and
a fourth deformable washer secured between the second mounting tab and the windshield in the vicinity of the second hole, and conforming to both a planar surface of the second mounting tab and a curved inner surface of the windshield.

14. The mounting assembly of claim 13, wherein said planar surface of the bracket is a first planar surface, the second deformable washer is disposed against a second planar surface of the bracket defined by the first mounting tab, the fourth deformable washer is disposed against a third planar surface defined by the second mounting tab, and the second and third planar surfaces are oriented at acute angles to the first planar surface.

15. The mounting assembly of claim 14, wherein the second and third planar surfaces are both substantially tangent to the curved inner surface of the windshield.

16. The mounting assembly of claim 12, wherein the first threaded fastener extends through third and fourth holes provided in an inner and an outer horizontal support bar of the windshield, and the second threaded fastener extends through fifth and sixth holes provided in the inner and the outer horizontal support bar of the windshield, the third and fourth holes being aligned with the first hole, and the fifth and sixth holes being aligned with the second hole.

17. The mounting assembly of claim 12, wherein the first and second mounting tabs are spaced apart from one another to define a spacing therebetween and a clearance is provided between the windshield and the bracket within said spacing.

18. A mounting assembly for securing a bag to a vehicle windshield having horizontal support bars, comprising:
a bracket located inboard of the windshield, including a body and first and second mounting tabs extending from the body, the first and second mounting tabs being spaced apart from one another to define a spacing therebetween, a clearance being provided between the windshield and the bracket within said spacing; and
a plurality of fasteners extending through a rear surface of the bag and through corresponding holes in a planar surface of the bracket to secure the bag to a planar surface of the body, wherein one of said fasteners extends through mounting holes provided in the windshield and the horizontal support bars.

19. The mounting assembly of claim 18, further comprising lips along the top and bottom edges of the first and second mounting tabs, said lips engaging one of the horizontal support bars to inhibit rotation of the bag with respect to the windshield.

20. The mounting assembly of claim 18, further comprising a standoff provided in the clearance between the windshield and the bracket, wherein said one of the fasteners extends through the standoff.
